(19) United States
(12) Patent Application Publication
(10) Pub. No.: US 2026/0303409 A1
(43) Pub. Date: Oct. 1, 2026

(54) NETWORK SWITCH AND OPERATION METHOD THEREOF

(71) Applicant: Realtek Semiconductor Corporation, Hsinchu (TW)

(72) Inventors: Ting Han LIN, Hsinchu (TW); Yung Kun LIN, Hsinchu (TW); Yen-Han HUANG, Hsinchu (TW)

(21) Appl. No.: 19/562,821

(22) Filed: Mar. 11, 2026

(30) Foreign Application Priority Data
Mar. 31, 2025 (TW) 114112402

(51) Int. Cl. H04L 12/46; H04J 3/06

(52) U.S. Cl. CPC H04L 12/4645; H04J 3/0661; H04L 12/4675

(57) ABSTRACT

A network switch includes a precision time protocol (PTP) circuit and a processor. The precision time protocol circuit is configured to determine whether a first precision time protocol packet carries a first virtual local area network (VLAN) tag. The processor is coupled to the precision time protocol circuit and is configured to: determine whether the first virtual local area network tag matches a first predetermined virtual local area network channel when the first precision time protocol packet carries the first virtual local area network tag; and when the first VLAN tag does not match the first predetermined virtual local area network channel, set a current virtual local area network channel in the first virtual local area network tag to be a second predetermined virtual local area network channel and perform a precision time protocol process through the second predetermined virtual local area network channel.

### RELATED APPLICATIONS

This application claims priority to Taiwanese Application Serial Number 114112402, filed March 31, 2025, which is herein incorporated by reference.

### BACKGROUND

### Technical Field

The present disclosure relates to network switch technology. More particularly, the present disclosure relates to a network switch and an operation method thereof, in which the network switch can adaptively utilize the virtual local area network (VLAN) to perform the precision time protocol (PTP).

### Description of Related Art

With development of technology, various network technologies have developed. For example, the virtual local area network utilizes specific network technology to arrange multiple devices in one network. These devices can utilize channels of the virtual local area network to perform different protocols.

However, in the related approaches, one network channel is used to execute a specific protocol. In this condition, when this specific protocol will be performed by another network channel, it needs to redefine the new network channel. This will take time and affect stability of the entire network.

### SUMMARY

Some aspects of the present disclosure are to provide a network switch. The network switch includes a precision time protocol circuit and a processor. The precision time protocol circuit is configured to determine whether a first precision time protocol packet carries a first virtual local area network tag. The processor is coupled to the precision time protocol circuit and is configured to: determine whether the first virtual local area network tag matches a first predetermined virtual local area network channel when the first precision time protocol packet carries the first virtual local area network tag; and when the first VLAN tag does not match the first predetermined virtual local area network channel, set a current virtual local area network channel in the first virtual local area network tag to be a second predetermined virtual local area network channel and perform a precision time protocol process through the second predetermined virtual local area network channel.

Some aspects of the present disclosure are to provide an operation method of a network switch. The operation method includes: determining, by a precision time protocol circuit in the network switch, whether a first precision time protocol packet carries a first virtual local area network tag; determining, by a processor in the network switch, whether the first virtual local area network tag matches a first predetermined virtual local area network channel when the first precision time protocol packet carries the first virtual local area network tag; and when the first virtual local area network tag does not match the first predetermined virtual local area network channel, setting, by the processor, a current virtual local area network channel in the first virtual local area network tag to be a second predetermined virtual local area network channel and perform a precision time protocol process through the second predetermined virtual local area network channel.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a network switch according to some embodiments of the present disclosure.

FIG. 2 is a flow diagram of an operation method of a network switch according to some embodiments of the present disclosure.

FIG. 3 is a schematic diagram of a precision time protocol packet according to some embodiments of the present disclosure.

### DETAILED DESCRIPTION

In the present disclosure, "connected" or "coupled" may refer to “electrically connected” or “electrically coupled.” "Connected" or "coupled" may also refer to operations or actions between two or more elements.

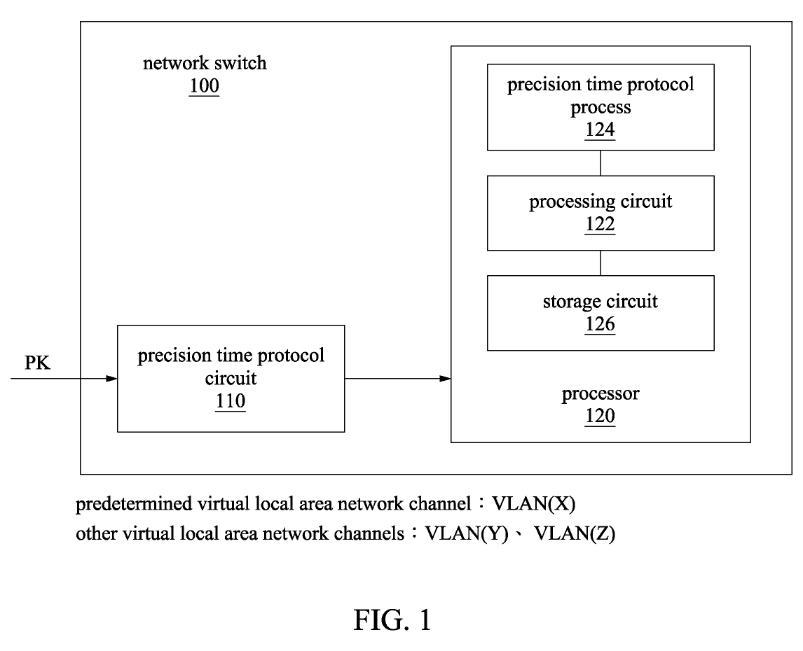

Reference is made to FIG. 1. FIG. 1 is a schematic diagram of a network switch 100 according to some embodiments of the present disclosure. In some embodiments, the network switch 100 can be applied in a vehicle network environment. In other words, the vehicle network environment can include multiple network switches 100.

As illustrated in FIG. 1, the network switch 100 includes a precision time protocol circuit 110 and a processor 120. The processor 120 is coupled to the precision time protocol circuit 110. In some embodiments, the precision time protocol circuit 110 is a precision time protocol receiver parser. In some embodiments, the processor 120 is a central processing unit (CPU).

The processor 120 includes a processing circuit 122, a precision time protocol process 124 and a storage circuit 126. The processing circuit 122 is coupled to the precision time protocol process 124 and the storage circuit 126.

In some embodiments, the processing circuit 122 is a hardware circuit in the central processing unit and mainly performs various calculation functions and various processing functions. In some embodiments, the precision time protocol process 124 is a non-transitory computer readable record medium, and the non-transitory computer readable record medium stores precision time protocol codes. The precision time protocol is a network protocol used to synchronize clocks of the entire network. In some embodiments, the storage circuit 126 is a flash memory, but the present disclosure is not limited thereto.

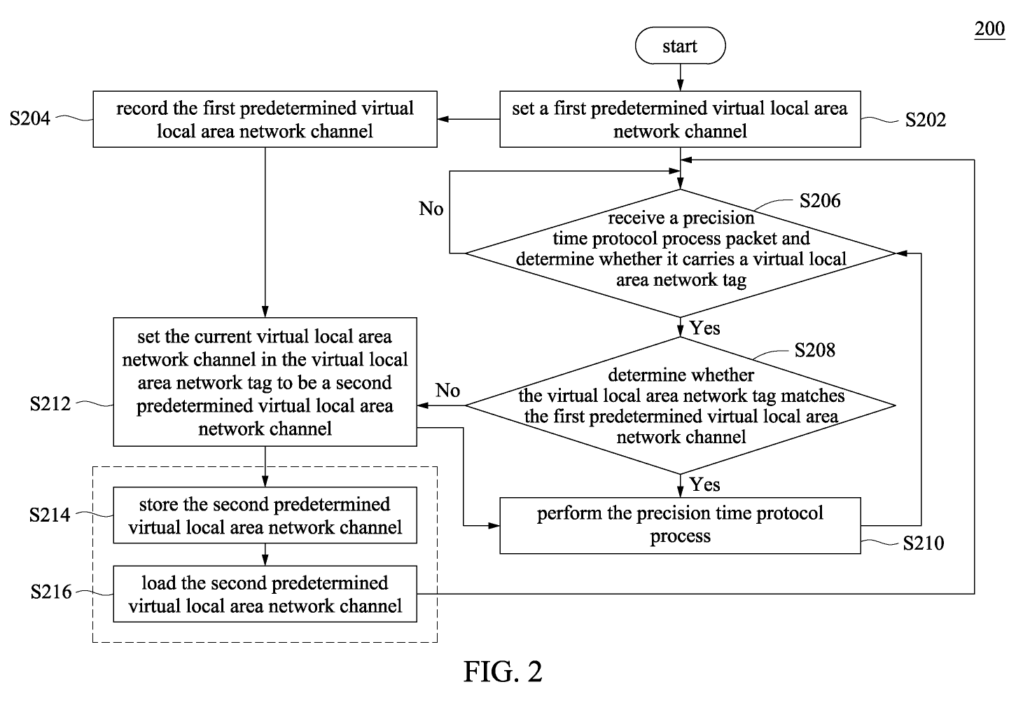

References are made to FIGS. 1 and 2. FIG. 2 is a flow diagram of an operation method 200 of a network switch according to some embodiments of the present disclosure. In some embodiments, the operation method 200 is applied to the network switch 100.

As illustrated in FIG. 2, the operation method 200 includes operation S202, operation S204, operation S206, operation S208, operation S210, operation S212, operation S214, and operation S216.

In operation S202, the processing circuit 122 in the processor 120 sets a first predetermined virtual local area network channel. To be more specific, after a boot process of the network switch 100, the processing circuit 122 in the processor 120 can set one of multiple candidate virtual local area network channels to be the first predetermined virtual local area network channel for the precision time protocol process 124.

For example, it is assumed that the candidate virtual local area network channels include a virtual local area network channel VLAN(X), a virtual local area network channel VLAN(Y), and a virtual local area network channel VLAN(Z). The processing circuit 122 in the processor 120 can set virtual local area network channel VLAN(X) to be the first predetermined virtual local area network. In other words, the virtual local area network channel VLAN(X) is utilized to perform the precision time protocol process 124. The virtual local area network channel VLAN(Y) and the virtual local area network channel VLAN(Z) are used for other applications.

In operation S204, the processing circuit 122 in the processor 120 records the first predetermined virtual local area network channel VLAN(X).

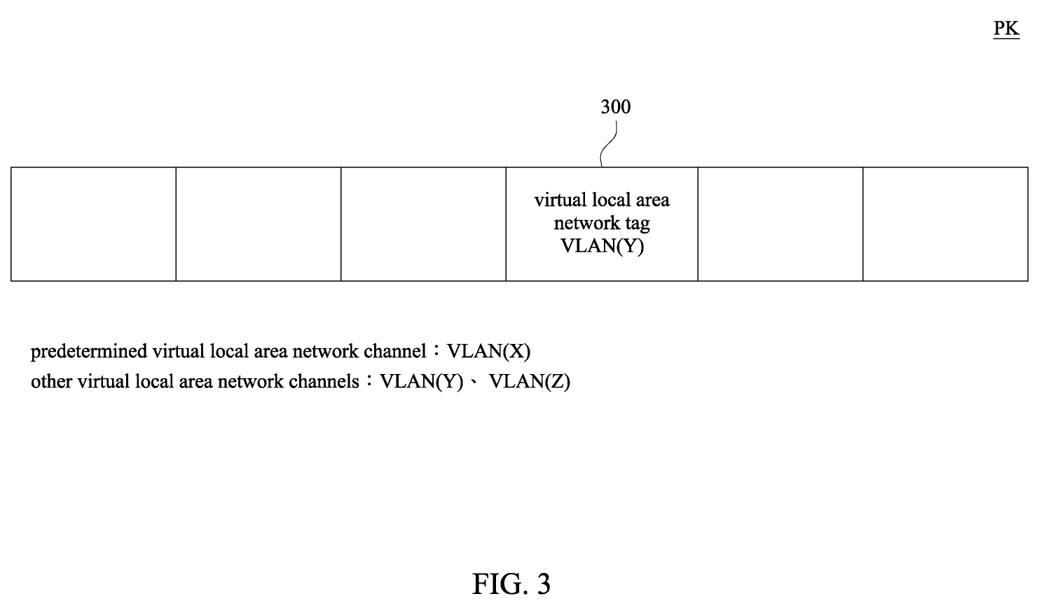

Then, references are made to FIGS. 1 to 3. FIG. 3 is a schematic diagram of a precision time protocol packet PK according to some embodiments of the present disclosure.

In operation S206, the precision time protocol circuit 110 receives the precision time protocol packet PK (first precision time protocol packet) and determines whether the precision time protocol packet PK carries a virtual local area network tag 300 (first virtual local area network tag).

When the precision time protocol packet PK carries the virtual local area network tag 300 (as shown in FIG. 3) (the determination result of operation S206 is “YES”), the precision time protocol circuit 110 transmits the precision time protocol packet PK to the processor 120 and it enters operation S208. When the precision time protocol packet PK does not carry the virtual local area network tag 300 (the determination result of operation S206 is “NO”), it stays in operation S206 to continue receiving the precision time protocol packet PK.

In operation S208, when the precision time protocol packet PK carries the virtual local area network tag 300, the processing circuit 122 in the processor 120 determines whether the virtual local area network tag 300 matches the first predetermined virtual local area network channel VLAN(X).

When the virtual local area network tag 300 matches the first predetermined virtual local area network channel VLAN(X) (the determination result of operation S208 is “YES”), it enters operation S210. When the virtual local area network tag 300 does not matches the first predetermined virtual local area network channel VLAN(X) (the determination result of operation S208 is “NO”), it enters operation S212.

In operation S210, when the virtual local area network tag 300 matches the first predetermined virtual local area network channel VLAN(X), the processing circuit 122 in the processor 120 performs the precision time protocol process 124 through the first predetermined virtual local area network channel VLAN(X).

However, as illustrated in FIG. 3, it is assumed that the virtual local area network tag 300 recodes the virtual local area network channel VLAN(Y). In other words, virtual local area network channel VLAN(Y) recoded in the virtual local area network tag 300 does not match the first predetermined virtual local area network channel VLAN(X). At this time, it enters operation S212. In operation S212, the processing circuit 122 in the processor 120 sets the current virtual local area network channel VLAN(Y) in the virtual local area network tag 300 to be a second predetermined virtual local area network channel.

Then, in operation S210, the processing circuit 122 in the processor 120 performs the precision time protocol process 124 through the second predetermined virtual local area network channel VLAN(Y).

In some related approaches, the network switch merely performs the precision time protocol process through one predetermined virtual local area network channel. When it intends to change this predetermined virtual local area network channel, this will take time and affect stability of the network switch and the entire network.

Compared to the aforementioned related approaches, in the present disclosure, it can dynamically set the current virtual local area network channel VLAN(Y) recoded in the virtual local area network tag 300 to be a new predetermined virtual local area network channel to perform the precision time protocol process 124 through the current virtual local area network channel VLAN(Y). Thus, it can dynamically and adaptively perform the precision time protocol process 124 so as to improve overall efficiency.

In addition, in operation S214, the processing circuit 122 in the processor 120 not only sets the current virtual local area network channel VLAN(Y) in the virtual local area network tag 300 to be the second predetermined virtual local area network channel, but also stores the second predetermined virtual local area network channel VLAN(Y) into the storage circuit 126.

Then, in operation S216, after a next boot process of the network switch 100, the processing circuit 122 in the processor 120 can load the second predetermined virtual local area network channel VLAN(Y) from the storage circuit 126.

Then, it returns operation S206. In operation S206, the precision time protocol circuit 110 continues to receive a new precision time protocol packet PK (second precision time protocol packet) (later than the aforementioned first precision time protocol packet) and continues to determine whether the new precision time protocol packet PK carries the virtual local area network tag 300 (second virtual local area network tag).

When the new precision time protocol packet PK carries the virtual local area network tag 300 (the determination result of operation S206 is “YES”), it enters operation S208 again. In operation S208, the processing circuit 122 in the processor 120 determines whether the virtual local area network tag 300 in the new precision time protocol packet PK matches the second predetermined virtual local area network channel VLAN(Y). When the virtual local area network tag 300 in the new precision time protocol packet PK matches the second predetermined virtual local area network channel VLAN(Y) (the determination result of operation S208 is “YES”), it enters operation S210 again. When the virtual local area network tag 300 in the new precision time protocol packet PK does not match the second predetermined virtual local area network channel VLAN(Y) (the determination result of operation S208 is “YES”), it enters operation S212 again.

In operation S210, the processing circuit 122 in the processor 120 performs the precision time protocol process 124 through the second predetermined virtual local area network channel VLAN(Y).

In operation S212, the processing circuit 122 in the processor 120 sets the current virtual local area network channel in the virtual local area network tag 300 to be a third predetermined virtual local area network channel. The subsequent operations are similar to the embodiments above.

In some embodiments, operation S214 and operation S216 can be omitted. Accordingly, it can save time for storing the predetermined virtual local area network channel into the storage circuit 126.

As described above, in the present disclosure, it can dynamically set a new predetermined virtual local area network channel to perform the precision time protocol process through the new predetermined virtual local area network channel. Thus, it can dynamically and adaptively perform the precision time protocol process to improve overall efficiency.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A network switch, comprising:
a precision time protocol (PTP) circuit configured to determine whether a first precision time protocol packet carries a first virtual local area network (VLAN) tag; and
a processor coupled to the precision time protocol circuit and configured to:
determine whether the first virtual local area network tag matches a first predetermined virtual local area network channel when the first precision time protocol packet carries the first virtual local area network tag; and
when the first virtual local area network tag does not match the first predetermined virtual local area network channel, set a current virtual local area network channel in the first virtual local area network tag to be a second predetermined virtual local area network channel and perform a precision time protocol process through the second predetermined virtual local area network channel.

2. The network switch of claim 1, wherein the processor is configured to:
after a boot process, for the precision time protocol process, set one of a plurality of candidate virtual local area network channels to be the first predetermined virtual local area network channel; and
record the first predetermined virtual local area network channel.

3. The network switch of claim 1, wherein the precision time protocol circuit is further configured to receive the first precision time protocol packet, and transmit the first precision time protocol packet to the processor when the first precision time protocol packet carries the first virtual local area network tag.

4. The network switch of claim 1, wherein the processor is further configured to:
perform the precision time protocol process through the first predetermined virtual local area network channel when the first virtual local area network tag matches the first predetermined virtual local area network channel.

5. The network switch of claim 1, wherein the processor further comprises a storage circuit, wherein the processor is configured to:
store the second predetermined virtual local area network channel into the storage circuit when the first virtual local area network tag does not match the first predetermined virtual local area network channel.

6. The network switch of claim 5, wherein the processor is further configured to:
after a next boot process, load the second predetermined virtual local area network channel from the storage circuit.

7. The network switch of claim 6, wherein the precision time protocol circuit is further configured to determine whether a second precision time protocol packet carries a second virtual local area network tag, wherein the second precision time protocol packet is later than the first precision time protocol packet.

8. The network switch of claim 7, wherein the processor is further configured to:
determine whether the second virtual local area network tag matches the second predetermined virtual local area network channel when the second precision time protocol packet carries the second virtual local area network tag; and
perform the precision time protocol process through the second predetermined virtual local area network channel when the second virtual local area network tag matches the second predetermined virtual local area network channel.

9. The network switch of claim 5, wherein the storage circuit is a flash memory.

10. The network switch of claim 1, wherein the network switch is applied in a vehicle network environment.

11. An operation method of a network switch, comprising:
determining, by a precision time protocol circuit in the network switch, whether a first precision time protocol packet carries a first virtual local area network tag;
determining, by a processor in the network switch, whether the first virtual local area network tag matches a first predetermined virtual local area network channel when the first precision time protocol packet carries the first virtual local area network tag; and
when the first virtual local area network tag does not match the first predetermined virtual local area network channel, setting, by the processor, a current virtual local area network channel in the first virtual local area network tag to be a second predetermined virtual local area network channel and perform a precision time protocol process through the second predetermined virtual local area network channel.

12. The operation method of the network switch of claim 11, further comprising:
after a boot process, for the precision time protocol process, setting, by the processor, one of a plurality of candidate virtual local area network channels to be the first predetermined virtual local area network channel; and
recording, by the processor, the first predetermined virtual local area network channel.

13. The operation method of the network switch of claim 11, further comprising:
receiving, by the precision time protocol circuit, the first precision time protocol packet; and
transmitting, by the precision time protocol circuit, the first precision time protocol packet to the processor when the first precision time protocol packet carries the first virtual local area network tag.

14. The operation method of the network switch of claim 11, further comprising:
performing, by the processor, the precision time protocol process through the first predetermined virtual local area network channel when the first virtual local area network tag matches the first predetermined virtual local area network channel.

15. The operation method of the network switch of claim 11, further comprising:
storing, by the processor, the second predetermined virtual local area network channel into a storage circuit when the first virtual local area network tag does not match the first predetermined virtual local area network channel.

16. The operation method of the network switch of claim 15, further comprising:
after a next boot process, loading, by the processor, the second predetermined virtual local area network channel from the storage circuit.

17. The operation method of the network switch of claim 16, further comprising:
determining, by the precision time protocol circuit, whether a second precision time protocol packet carries a second virtual local area network tag,
wherein the second precision time protocol packet is later than the first precision time protocol packet.

18. The operation method of the network switch of claim 17, further comprising:
determining, by the processor, whether the second virtual local area network tag matches the second predetermined virtual local area network channel when the second precision time protocol packet carries the second virtual local area network tag; and
performing, by the processor, the precision time protocol process through the second predetermined virtual local area network channel when the second virtual local area network tag matches the second predetermined virtual local area network channel.

19. The operation method of the network switch of claim 15, wherein the storage circuit is a flash memory.

20. The operation method of the network switch of claim 11, wherein the network switch is applied in a vehicle network environment.
